(19) United States
(12) Patent Application Publication
(10) Pub. No.: US 2026/0250212 A1
(43) Pub. Date: Aug. 27, 2026

(54) A COMPOSITION OF POLYHALITE AND MANURE AND USES THEREOF

(71) Applicant: ICL EUROPE COOPERATIEF U.A., Amsterdam (NL)

(72) Inventors: Cristian TERRONES, Wijk bij Duurstede (NL); Dan NOIMAN, Beer Sheva (IL); Shay MEY-TAL, Herzliya (IL); Amir GERBER, Sheizaf (IL); Khalil ABU-RABEAH, Beer Sheva (IL)

(21) Appl. No.: 19/129,683

(22) PCT Filed: Nov. 18, 2023
(86) PCT No.: PCT/IL2023/051192

§ 371 Date: May 14, 2025

Related U.S. Application Data
(60) Provisional application No. 63/426,375, filed on Nov. 18, 2022.

(51) Int. Cl. C05D 1/04; A01C 3/00

(52) U.S. Cl. CPC C05D 1/04; A01C 3/00

(57) ABSTRACT

According to some embodiments, there is provided herein a composition comprising Polyhalite and manure.

### FIELD OF THE INVENTION

The present invention relates to the field of agriculture, specifically to the reduction of ammonia emission during agricultural applications.

### BACKGROUND OF THE INVENTION

Air pollution from human activities presents a major challenge for most nations on earth. It can originate from multiple sources, including transport and industry, and is most commonly associated with the by-products of fuel combustion. Agricultural activities contribute to air pollution indirectly through the emission of ammonia (NH₃), N₂O and/or CH₄, which combine in the atmosphere with other pollutant materials from a range of sources to become fine particulate matter. Particulate matter is an air pollutant material of particular concern as it can cause significant impact to human health and wellbeing.

Ammonia (NH₃), for example, has significant impacts on the environment, which can influence climate and air quality and cause acidification and eutrophication in terrestrial and aquatic ecosystems. Agricultural activities are the main sources of NH₃ emissions globally, particularly from livestock systems and fertiliser management.

Reducing ammonia emission is an essential objective for the agricultural industry, both due to the influence this has on air pollution and population health, and also due to the environmental impact caused by ammonia pollution. Additionally, N is a valuable production material and enhancing N use efficiencies and reducing environmental losses is a core future farming strategy. Improving resource utilization and precision in terms of nutrient management acts to improve farm business efficiency and is necessary to increase future sustainability within the agricultural sector.

### BRIEF DESCRIPTION OF THE FIGURES

FIG. 1 depicts graphs demonstrating the effect of polyhalite addition to cattle (CS_poly) and pig (PS_poly) compared to no addition of polyhalite, in accordance with some demonstrative embodiments.

FIG. 2 depicts a graph demonstrating the emission rate vs. time (days) of the composition of the present invention vs. control in accordance with some demonstrative embodiments.

FIG. 3 depicts a graph demonstrating the emission rate vs. time (days) of the composition of the present invention vs. control in accordance with some demonstrative embodiments.

FIG. 4 depicts a graph demonstrating NH₃ emissions vs. time (days) of the composition of the present invention vs. control when piles are turned over in accordance with some demonstrative embodiments.

### SUMMARY OF THE INVENTION

According to some demonstrative embodiments, there is provided herein a composition comprising Polyhalite and manure.

According to some embodiments, the composition may reduce gas emissions from the manure in an amount of 30% or more, after two days of application of the composition to the ground, in comparison to manure only.

According to some embodiments, the Polyhalite may be in a concentration between 0.1-10% w/w, preferably, between 0.1-5% w/w.

According to some embodiments, the composition may further include Zeolite.

According to some embodiments, the zeolite may be in a concentration of between 0.1-5% w/w.

According to some embodiments, the a method for reducing the NH₃ emission from animal manure comprising at least two steps, a first step comprising injecting said animal manure into a soil and a second step comprising applying polyhalite over said injected manure.

According to some embodiments, the polyhalite may be in a solid form selected from the group including a powder, granule and the like According to some embodiments, the polyhalite may be in liquid form selected from the group including melt or a suspension.

According to some embodiments, the polyhalite may be in the form of a suspension having a concentration of no more than 5% w/w.

According to some embodiments, the second step may include spraying the polyhalite suspension, preferably with Zeolite, over said injected manure.

According to some embodiments, the ratio between the polyhalite and the manure may be 1:19, respectively.

According to some demonstrative embodiments, there is provided herein a composition comprising Polyhalite and manure, wherein the Polyhalite may be in a concentration between 0.1-10% w/w.

According to some embodiments, the Polyhalite may be in a concentration between 0.5-5% w/w and said manure is solid.

According to some embodiments, the composition may further include Zeolite in a concentration of between 0.1-5% w/w.

According to some embodiments, the composition may further include an additive selected from the group including Urease inhibitor, Nitrification inhibitor, Denitrification inhibitor, Basal rock, Biochar, Hydrochar or a combination thereof.

According to some embodiments, the ratio between the polyhalite and the manure may be 1:19, respectively.

According to some embodiments, there is provided herein a method for reducing the NH₃ emission from animal manure application comprising at least two steps, a first step comprising applying the animal manure into a soil and a second step comprising applying polyhalite over the applied manure.

According to some embodiments, there is provided herein a method for reducing the NH₃ emission from animal manure composting comprising mixing polyhalite powder with a fresh manure prepare compost.

According to some embodiments, the polyhalite may be in a solid form selected from the group including a powder, granule and the like

According to some embodiments, the polyhalite may be in liquid form selected from the group including melt or a suspension.

According to some embodiments, the Polyhalite may be in the form of a suspension having a concentration of no more than 10% w/w Polyhalite. According to some embodiments, the second step may include spraying the polyhalite suspension over the applied manure or manure composting pile.

According to some embodiments, there is provided herein a method for reducing the NH₃ emission from animal manure comprising mixing polyhalite and Zeolite with manure to provide a fertilizer composition, wherein said composition is spread in an agricultural field or is piled and treated for composting.

According to some embodiments, the ratio of Polyhalite to Zeolite may be 1:1, and concentration of polyhalite and Zeolite is less than 10% w/w each.

According to some embodiments, there is provided herein a use of Polyhalite for the reduction of NH₃, N₂O, CH₄ or CO₂ from animal manure, comprising applying said Polyhalite to said animal manure to provide for a polyhalite-manure composition.

According to some embodiments, the polyhalite-manure composition may comprise less than 10% w/w of Polyhalite, and includes applying said polyhalite to said manure in a solid powder form.

### DETAILED DESCRIPTION OF THE INVENTION

According to some demonstrative embodiments, there is provided herein a composition of manure and polyhalite.

According to some embodiments, the term “manure” may refer to any suitable organic matter that is used as organic fertilizer in agriculture consisting of animal feces.

According to some embodiments, the manure may be liquid or solid.

According to some embodiments, the manures may contribute to the fertility of soil by adding organic matter and nutrients, such as nitrogen, that are utilized by bacteria, fungi and other organisms in the soil According to some embodiments, Polyhalite is an evaporite mineral, a hydrated sulfate of potassium, calcium and magnesium with formula: K₂Ca₂Mg(SO₄)₄·2H₂O. Polyhalite is used as a fertilizer since it contains four important nutrients and is low in chloride:
48% SO₃ as sulfate
14% K₂O
6% MgO
17% CaO

According to some demonstrative embodiments, the unique addition of polyhalite may reduce the ammonia emissions from the manure.

According to some embodiments, the addition of polyhalite to the manure, especially in concentrations of 20% w/w or less, preferably 10% or less, may reduce gas emissions from the manure in about 30% or more, after two days of application of the composition to the ground, in comparison to manure only.

According to some demonstrative embodiments, the concentration of polyhalite in the composition can vary and range from 0.1%-50% w/w, preferably the polyhalite concentration is no more than 20% w/w, more preferably, no more than 10% w/w, most preferably, no more than 5% w/w.

According to some embodiments, the composition of polyhalite and manure may further include an additive selected from the group including Urease inhibitor, Nitrification inhibitor, Denitrification inhibitor, Basal rock, Biochar, Hydrochar or a combination thereof.

According to some embodiments, there is provided herein a method for reducing the NH₃ emission from animal manure comprising at least two steps, a first step comprising injecting animal manure into the soil and a second step including applying polyhalite over the manure.

According to some embodiments, the polyhalite may be in a solid form, for example a powder, granule and the like or in liquid form, for example, a melt or a suspension.

According to some embodiments, preferably, the polyhalite is in the form of a suspension, e.g., having a concentration of no more than 5% w/w.

According to some embodiments, the second step may include spraying the polyhalite suspension over the manure.

According to some other embodiments, there is provided herein a method for reducing the NH₃ emission from animal manure comprising mixing polyhalite with manure, e.g., in the form of powder, to yield a Polyahlite-manure composition.

According to some embodiments, the ratio between the polyhalite and manure is 1:19, respectively.

According to some embodiments, the composition of the present invention may comprise one or more additives selected from the group including Olivine, Pyroxene, Zeolite, Basalt, Aluminosilicate rocks, Phosphogypsum, Magnesium salts, phosphorus salts, CuSO₄, FeSO₄, Urease inhibitor, Nitrification inhibitor, Denitrification inhibitor, Calcium Cyanamide, Biochar, Hydrochar, charcoal, lignite, bacterial powder, or a combination thereof.

According to some demonstrative embodiments, the composition of the present invention may preferably include Olivine, Pyroxene, Zeolite, Basalt or Aluminosilicate rocks in addition to polyhalite, for example, to provide for a synergistic effect in the reduction of the NH₃ and/or CO₂ emissions.

According to some embodiments, the concentration of the additives in the composition of the present invention may preferably be less than 10% w/w.

According to some demonstrative embodiments, the composition of the present invention may preferably include zeolite in addition to polyhalite, for example, to provide for a synergistic effect in the reduction of the NH₃ emissions.

As is known, Ureases decomposes urea in the soil to NH₃.

There is an equilibrium between ammonia and ammonium

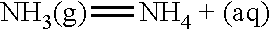

According to some embodiments, by using polyhalite in combination with manure, the NH₃ emission may decrease as NH₄_{⁺} may react with Mg⁺² and PO₄_{⁺³} and settle down as struvite —Mg(NH₄)PO₄.

The equilibrium moved to the right side.

According to some embodiments, adding zeolite to the system may create one more equilibrium:

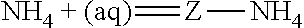

wherein Z represents zeolite.

According to some embodiments, on one side of the equation, it may reduce the emission of NH₃ and on the other side N value is kept.

According to some demonstrative embodiments, the concentration of the zeolite in the composition may be no more than 10% w/w, preferably, no more than 5% w/w.

According to some preferred embodiments, the ratio between the zeolite and polyhalite in the composition may be 1:3 to 3:1, preferably 1:1.

According to some embodiments, the composition of the present invention may include the combination of Polyhalite and manure with a “struvite forming agent” selected from the group including Phosphogypsum, Magnesium salts and phosphorus salts.

According to some embodiments, the use of one or more struvite forming agents may reduce NH₃ emissions by reaction with NH₃ and creation of Struvite. According to some embodiments, Struvite may also provide a stable NH₄ source for the crop. The concentration of Phosphogypsum, Magnesium salts, phosphorus salts or a combination thereof in the composition may not exceed 10%. According to some embodiments, the ratio between Magnesium and Phosphorus may be between 3:1 to 1:3.

According to some demonstrative embodiments, the composition of the present invention may also include one or more of CuSO4 or FeSO4, which can prevent or significantly reduce the formation of H₂S gas in case of anaerobic conditions. The concentration of CuSO4, FeSO4 or a combination thereof in the composition may preferably be below 0.5%.

According to some embodiments, the some of the additives mentioned hereinabove, such as, Urease inhibitor, Nitrification inhibitor, Denitrification inhibitor and Calcium Cyanamide, may significantly reduce NH₃ and N₂O emissions by reacting with certain enzymes and inhibiting their activity. The concentration of Urease inhibitor, Nitrification inhibitor, Denitrification inhibitor, Calcium Cyanamide or a combination thereof in the composition should preferably be below 1%.

According to some embodiments, some of the additives mentioned hereinabove Biochar, Hydrochar, charcoal and lignite, may be reduce NH₃ and CO₂ emissions by locking those gases in their surface and bulk macropores and reduce CH₄ and N₂O emissions by proving higher porosity and better aeration of the manure. According to some embodiments, the concentration of Biochar, Hydrochar, charcoal, lignite, or a combination thereof in the composition may preferably be below 10% w/w.

According to some embodiments, the composition of the present invention may also include bacterial powder which can accelerate the decomposition of the manure and thus reduce NH₃, N₂O, CH₄ or CO₂ emissions by bacterial activity. According to some embodiments, the concentration of bacterial powder in the composition may preferably be below 2% w/w.

According to some embodiments, there is provided herein a method for reducing the NH₃ emission from animal manure comprising at least two steps, a first step comprising injecting animal manure into the soil and a second step including applying a suspension of polyhalite and zeolite over the manure.

According to some embodiments, there is provided herein a method for reducing the NH₃, N₂O, CH₄ or CO₂ emission from animal manure via direct application of polyhalite to the manure, e.g., either by mixing the manure slurry with a Polyhalite blend and applying the mixture in the field or by first applying manure to the field followed by applying Polyhalite blend on top of the manure.

According to some embodiments, there is provided herein a method for reducing the NH₃ and NH₃, N₂O, CH₄ or CO₂ emission from animal manure composting comprising of mixing the Polyhalite blend with a fresh manure and follow the standard procedure of compost preparation.

According to some embodiments, the Polyhalite blend may be in a powder, granule, solution, or suspension form.

According to some embodiments, there is provided herein a use of Polyhalite blend for the reduction of NH₃, N₂O, CH₄ or CO₂ from animal manure by directly applying Polyhalite to animal manure.

According to some embodiments, there is provided herein a use of polyhalite and zeolite for reducing the NH₃ emission from animal manure comprising applying a suspension of polyhalite and zeolite over the manure.

According to some demonstrative embodiments, the use of a suspension of Polyhalite, optionally with Zeolite, is preferable both due to the better spread of the components of the suspension, but also for the enhanced reduction of NH₃ emission due to the solubility of the substances in the suspension.

According to some demonstrative embodiments, there is provided herein a use of polyhalite, preferably is the form of a suspension, optionally with the addition of Zeolite, for covering cattle manure on barns, cowshed or dairy farms.

According to some embodiments, there is provided herein a use of Polyhalite for the reduction of NH₃, N₂O, CH₄ or CO₂ from animal manure, comprising applying said Polyhalite said animal manure.

According to some embodiments, the composition may facilitate a controlled release of nutrients in the soil, where the release rate of potassium, calcium, and magnesium from polyhalite is modulated by the composition of manure. This provides a sustained nutrient supply to plants.

In certain embodiments, the composition may be engineered to release nutrients over a period of 30-60 days, ideal for crop cycles. For instance, a composition with 4-7% w/w polyhalite may release potassium at a rate of 0.5-0.7% per day under typical soil pH conditions.

According to some demonstrative embodiments, the ratio of manure to polyhalite can be varied based on specific crop needs or soil conditions. This allows for customization of the fertilizer composition to suit various agricultural requirements.

Some embodiments could specify ratios such as 9:1, 15:1, and 20:1 (manure to polyhalite) for different crops like corn, wheat, and soybeans, respectively, based on their nutrient requirements. This customization allows for optimization of fertilizer use efficiency.

Some embodiments may focus on the effectiveness of the composition in different climatic conditions, such as arid or humid climates, ensuring its versatility across a range of environmental settings.

Embodiments may include formulations optimized for arid climates with higher polyhalite concentrations (up to 10% w/w) to ensure nutrient availability in low-moisture soils, and formulations for humid climates with lower concentrations (around 2-5% w/w).

According to certain embodiments, there is provided a method of manufacturing the composition which includes steps such as mixing, composting, or fermenting manure with polyhalite under controlled conditions to enhance the effectiveness of the final product.

According to some embodiments, the process may involve a two-stage mixing and curing process, where manure and polyhalite are first mixed at a 20:1 ratio, then cured for 14 days at 30° C. to enhance nutrient integration.

According to some embodiments, different formulations of the composition may be developed for different types of manure, such as poultry, cattle, or swine manure, to enhance the effectiveness based on the specific properties of each type of manure.

Formulations might vary with manure types, such as a higher preferable polyhalite ratio 5-10% w/w for poultry manure which is richer in nitrogen compared to a preferable 0.5-5% w/w ratio for cattle manure.

According to some embodiments of the present invention, there is provided a novel agricultural composition consisting of animal manure and polyhalite. The animal manure, which can be either poultry, cattle or pig slurry, is combined with polyhalite at a specific concentration, for example around 0.5-10% w/w, preferably 2-5%.

According to some demonstrative embodiments, it is expected that high concentrations of Polyhalite, e.g., 20% and above, would cause higher reductions in gas emissions from the manure. For example it is expected that concentrations of 20% or more of Polyhalite would yield the most effective results in terms of reduction in gas emissions, yet it was surprisingly found that best results are achieved when less than 20% Polyhalite is used, preferably, 10% w/w or less.

According to some embodiments, the addition of polyhalite to the manure, especially in concentrations of 20% w/w or less, preferably 10% or less, may reduce gas emissions, e.g, NH₃, from the manure in about 30% or more, after two days of application of the composition to the ground, in comparison to manure only.

According to some embodiments, the method for preparing this composition may involve a precise mixing process. For instance, 100 grams of polyhalite is thoroughly mixed with 2.0 kilograms of animal slurry. This preparation is typically done 1-2 hours before the application to ensure a homogeneous mixture. Such preparation is crucial as it influences the effectiveness of the composition in reducing emissions once applied to the soil.

In terms of application, the invention include a method that closely simulates sod injection. This involves creating open slots in the soil, into which the manure-polyhalite mixture is applied. The specific application rate considered optimal in some embodiments is equivalent to 20 tons per hectare. According to some embodiments, the preferred soil type for this application is a loamy sandy soil, characterized by a pH range of 6.5-7, which represents typical soil conditions in many agricultural settings.

According to some embodiments, the application of the manure-polyhalite composition shows an immediate reduction in ammonia emissions, estimated to be around 35-40% in the first few days following application. This reduction trend is observed consistently across different types of manures, such as poultry, cattle and pig slurry, demonstrating the versatility of the composition.

Furthermore, the invention offers notable advantages over conventional manure application methods. One such advantage according to some embodiments, is the sustained reduction in emissions over time, which is not typically observed with traditional manure applications. Additionally, the composition is adaptable to various types of manures and soil conditions, making it a versatile solution for diverse agricultural needs.

According to some embodiments, the environmental impact of this invention is significant. By reducing ammonia and greenhouse gas emissions, the composition contributes to lowering air pollution and mitigating the environmental footprint of agricultural practices. Its adaptability to poultry, cattle and pig manure, along with its effectiveness in various soil types, underscores its potential as a sustainable agricultural solution.

According to some embodiments, there is provided herein a composition of manure and polyhalite that is not only effective in enhancing soil fertility but also plays a crucial role in reducing harmful emissions from agricultural practices. Its method of preparation, application, and the demonstrated efficacy in emission reduction position it as an innovative solution in the field of environmental management in agriculture.

According to some demonstrative embodiments, there is provided herein a method for reducing ammonia (NH₃) emissions from animal manure in agricultural practices. The method comprises two primary steps: applying, e.g., injecting, animal manure into soil, followed by applying polyhalite over the applied manure. This process aims to mitigate the environmental impact of NH₃ emissions typically associated with the use of animal manure as a fertilizer.

According to some embodiments, the method may include a reduction of at least 30% in gas emissions after two days from application (application relates to the act of applying the manure and polyhalite to the ground).

According to some embodiments, the first step of the method may include the injection of animal manure into the soil. This step is crucial for placing the manure beneath the soil surface, which helps in minimizing direct emissions of ammonia into the atmosphere. The injection can be performed using standard agricultural equipment designed for subsurface manure application. This technique may ensure that the manure is effectively incorporated into the soil, enhancing its utility as a fertilizer while reducing its environmental footprint.

According to some embodiments, following the manure injection, polyhalite may be applied over the injected area. The application of polyhalite can be tailored according to its physical form, which includes solid (powder or granule) or liquid (melt or suspension).

In some embodiments, the polyhalite used is in a solid form, such as a powder or granules. This form may allow for easy spreading over the soil surface and ensures uniform coverage over the injected manure. The solid polyhalite may slowly dissolve into the soil, interacting with the manure to reduce ammonia emissions.

In other embodiments, polyhalite may be applied in a liquid form, either as a melt or a suspension. The suspension form, in particular, is preferred in certain scenarios due to its ease of application and ability to cover the soil surface uniformly. The concentration of polyhalite in the suspension is maintained at no more than 10% w/w, preferably 5% w/w, to ensure optimal effectiveness.

According to some embodiments, the method may include an embodiment where the polyhalite suspension may be sprayed over the injected manure. This technique allows for a precise and even application, ensuring that the polyhalite is adequately distributed across the area of interest.

According to some embodiments, in addition to the polyhalite application, the method may include an embodiment where polyhalite is mixed with zeolite and manure to create a fertilizer composition. This composition is then spread in an agricultural field. The combination of polyhalite and zeolite, both known for their nutrient and emission-reducing properties, enhances the effectiveness of the fertilizer while concurrently reducing ammonia emissions.

According to some embodiments, the preferred ratio of polyhalite to zeolite in this composition is 1:1. The concentration of both polyhalite and zeolite in the mixture is maintained at less than 10% w/w each. This specific ratio and concentration are designed to optimize the emission-reducing capabilities of the composition while maintaining its effectiveness as a fertilizer.

In summary, the invention provides a multi-faceted approach to reducing ammonia emissions from animal manure used in agriculture. Through the innovative use of polyhalite and zeolite, in combination with specific application techniques, this method not only enhances the environmental sustainability of agricultural practices but also maintains the efficacy of manure as a fertilizer. The versatility of the method in accommodating different forms of polyhalite and the inclusion of zeolite broadens its applicability across various agricultural settings.

### EXAMPLES

### Example 1

An experiment was designed to test the effect of polyhalite for its potential to reduce ammonia emission from animal manures after application and if it affects CH₄ and N₂O emission from slurry.

### Experimental Design

An NH₃ emission experiment with flux chambers is set up in the lab with the following treatments:
1. Zero (no slurry application)
2. Cattle slurry, 20 m³/ha (CS)
3. Cattle slurry, 20 m³/ha+5% polyhalite (w/w) mixed through slurry (CS_poly)
4. Pig slurry, 20 m³/ha (PS)
5. Pig slurry, 20 m³/ha+5% polyhalite (w/w) mixed through slurry (PS_poly)

In this experiment the slurry is applied in the soil in open slots to simulate sod injection. The preferred soil to use is a loamy sandy soil with a pH water of 6.5-7 and a “normal” fertility. The setup is a randomized block design with 8 repeats. This results in 40 experimental units.

### Setup

To simulate sod injection an “aluminum cake mold” of 21 cm in length, 11 cm width and a height of 5.4 cm, was used. This was filled with 1000 gram moist loamy sand. The soil was lightly pressed to get some compaction and a flat surface. An open slot is pressed into soil via a wooden disc—with the same size length as the mold—on which a parallel triangle 20 cm long, 3 cm wide and 1.9 cm depth was mounted. In the resulting open slot, 73.1 gram well-mixed cattle or pig slurry was applied with a spoon. This is equivalent with 20 ton per ha. This amount was also applied at treatments 3 and 5 (the results will be corrected for the 5% lower amount of slurry) to ensure the same filling grade of the slots. The slurries 3 and 5 were prepared 1-2 hrs before application by mixing 100 gram polyhalite with 2.0 kg of slurry. Treatment 1 did not receive any slurry in the open slot. The used soil (Table 1) was homogenized the week before the start of the experiment. Some water was mixed true it to get a moisty soil (16% w/w). The pH of the soil (measured in CaCl₂) was 5.8. This corresponds to a pH water of 6.5-6.8. Immediately after adding slurry to the soil an acid sink is placed on top of the soil and the whole is sealed with a bucket after placing an acid trap.

TABLE 1
Soil properties of the sandy soil used for the pot trial

| Parameter | Units | Value |
|---|---|---|
| Organic matter* | % | 1.9 |
| Sand* | % | 78 |
| Silt* | % | 15 |
| Clay* | % | 5 |
| CEC* | mmol+/kg | 38 |
| N-total* | g/kg | 0.790 |
| P—Al*** | mg P2O5/100 g | 55 |
| pH** | | 5.8 |
| P** | mg P/kg | 2.3 |
| S** | mg/kg | 160 |
| K** | mg/kg | 5.5 |
| Mg** | mg/kg | 45 |

*NIR,
**0.01M CaCl2 extraction &
***Ammonium lactate.

### Gaseous Measurements

Ammonia was measured by placing an acid trap approximately 4 cm above the soil surface. The acid trap consists of a 10 cm Petri dish filled with 20 ml 0.025 N HCl. As soon as the trap is placed the cake mold is closed with a plastic pot (10 1). The acid traps were aimed to be replaced regularly after 1, 2, 3, 4, 7, 8, 9, 10 and 14 days. The acid is transferred into a lockable test tube. In the lab the NH₃ concentration is determined using standard procedures.

The greenhouse gasses CO₂, N₂O and CH₄ are measured using a PAS analyzer (photo acoustic analyzer). For these measurement similar pots were used but now with two closeable openings to connect the PAS analyzer. With the analyzer air from the headspace is pumped around (in a closed loop) after about a minute equilibration the N₂O/CH₄/CO₂ concentration is measured. This will be done after about 0.5 hrs closure. To ensure fixed times between closing the flux chamber and the PAS measurement, they will be closed within short time intervals after each other. The measurements were aimed to take place after day 1, 2, 3, 4, 7, 8, 9, 10 and 14 days and start immediately after the first round acid traps have been removed. After the measurement of CO₂, N₂O and CH₄ a new acid trap is placed and the flux chamber remains closed up to the next replacement followed by placing the plastic pot with two closeable openings to connect the PAS analyzer. This procedure is continued up to the last measurement day.

### Experimental Details

The trial was executed between May 31 and June 10. The cake molds with soil were prepared a few days before and were covered to prevent drying out of the soil. On May 31 first the mixtures of slurry with polyhalite were prepared and after mixing with a mixer closed in a bucket which thereafter was closed up to application into the open slots. The same was done with slurry without polyhalite. After preparing the slurry mixtures the 32 cake mold were filled within 1 hr with the slurry, always using the same amount. Usually within 15 minutes after filling the molds were covered with the 10 liter plastic pot with the acid trap in it. On the first day ammonia was measured for about half hour shortly after the start of the experiment for half an hour, followed by a Petri dish exchange after hrs, after ~1 day, 2, 3.3, 4.3, 7 and 10 days. It was decided to exchange also on the first day because from other experiments it became clear that if there are changes they often most prominent during the first day. The NH₃ analysis results from the lab were usually available within a day.

The measurement of the greenhouse gasses from start to end took about 1.5-2 hrs. and started after the exchange of the first NH₃ acid trap.

During this time there was no acid trap present. A new acid trap was placed after finishing the greenhouse gas measurements. To get a continuous period the results were linear extrapolated to cover the period of measuring greenhouse gasses, assuming that the emission pattern is representative for the whole interval between measurements. Also the greenhouse gas measurements were extrapolated, assuming that they are representative for the foregoing period (interval).

The used slurries were analyzed at the Eurofins lab in Wageningen. The composition of the cattle slurry was known before the start of the experiment.

The temperature was monitored during the experiment and varied between 18 and 20 degrees, with as extreme 17 and 21° C.

With the PAS analyzer NH₃ concentration was also measured.

TABLE 2
Slurry composition (g per kg).

| | Cattle | Pig |
|---|---|---|
| Composition | slurry* | slurry** |
| Dry matter | 118 | 111 |
| Ash | 35 | 22 |
| Organic matter | 83 | 89 |
| Total N | 3.42 | 6.89 |
| NH4—N | 1.1 | 4.1 |
| Norg | 2.3 | 2.8 |
| P2O5 | 1.97 | 3.78 |
| K2O | 5.3 | 4.5 |
| MgO | 2.2 | 2.2 |
| Na2O | 0.5 | 1.1 |

*results of May 25 and
**results of June 20

### Results

### Results NH₃

In total 20 m³ cattle (CS, with 1.1 kg NH₄—N m³) and pig slurry (PS, with 2.8 kg NH₄—N m³) without and with 5% polyhalite was applied on a hectare basis. The treatments with polyhalite are corrected for the dilution with polyhalite (by multiplying with 1.05). The application of polyhalite (Table 3) showed immediately a reduction effect, which was roughly the same for CS as for PS, about 35-40%, during the first 4 days, where after it weakened somewhat. The pattern in reduction was exactly the same with the Petri-dishes as with the PAS-analyzer. However the overall level of emission was lower with the PAS-analyzer (30-40%). Most likely this is due to the increase in concentration of NH₃ in the headspace which hampers emission as time goes on. After 10 days the cumulative emission amounted to 17, 12, 21 and 13% of the applied NH₄—N for respectively CS, CS_poly, PS ad PS_poly. In the Netherlands the average emission factor for sod injection is 17% of the applied NH₄—N. Although the total levels are quite similar the emission pattern is different. In the field 80% of the total emission is normally measured on the first two days. In the lab trial the emission continued for 10 days. This is most likely due to the permanent closure which prevents drying out of slurry and crust formation on top of the slurry (in contrast to sod injection in the field). The same reduction pattern for CS and PS (even somewhat larger reduction than CS) is remarkable because the amount of NH₄—N with PS was 2.5 times higher. This indicates that a kind of adsorption or absorption process of NH₄_{⁺} or NH₃ takes place. It might be that polyhalite has a large specific surface, making adsorption of NH₃ possible. Another possibility is that the formation of struvite takes place. The magnesium in the polyhalite reacts with ammonium and phosphate in the slurry to form struvite. However the P to NH₄—N ratio is not the same for CS (with 0.86 kg P m3) and PS (with 1.65 kg P m3) on a molar basis, being 0.35 and 0.27.

TABLE 3
Cumulative NH₃—N emission from day 0 to 10, measured with petri-dishes
(kg N/ha and % of applied NH₄—N) and with the PAS analyzer. Also
the relative emission of “poly” versus the untreated slurry is presented.

| | | | | | | | | |
|---|---|---|---|---|---|---|---|---|
| Treatment | Day 0.04 | Day 0.3 | Day 1 | Day 2 | Day 3 | Day 4 | Day 7 | Day 10 |

Petri dishes in kgN/ha

| | | | | | | | | |
|---|---|---|---|---|---|---|---|---|
| 0 | 0.001 a | 0.00 a | 0.01 a | 0.01 a | 0.02 a | 0.02 a | 0.03 a | 0.03 a |
| CS | 0.014 b | 0.35 d | 1.46 c | 2.44 c | 3.20 c | 3.46 c | 3.63 c | 3.67 c |
| CS_poly | 0.008 b | 0.21 b | 0.81 b | 1.39 b | 1.92 b | 2.19 b | 2.55 b | 2.67 b |
| PS | 0.036 d | 0.58 e | 2.32 d | 5.44 e | 7.95 e | 9.43 e | 11.33 e | 11.88 e |
| PS_poly | 0.021 c | 0.30 c | 1.41 c | 3.14 d | 4.64 d | 5.51 d | 6.67 d | 7.10 d |
| Fprob | <0.001 | <0.001 | <0.001 | <0.001 | <0.001 | <0.001 | <0.001 | <0.001 |

Petri dishes in % of N

| | | | | | | | | |
|---|---|---|---|---|---|---|---|---|
| CS | 0.062 b | 1.58 d | 6.63 c | 11.11 c | 14.52 c | 15.73 c | 16.48 c | 16.68 c |
| CS_poly | 0.035 b | 0.97 b | 3.70 b | 6.33 b | 8.73 b | 9.94 b | 11.58 b | 12.12 b |
| PS | 0.065 d | 1.04 e | 4.14 d | 9.72 e | 14.19 e | 16.84 e | 20.23 e | 21.22 e |
| PS_poly | 0.037 c | 0.54 c | 2.52 c | 5.60 d | 8.28 d | 9.83 d | 11.91 d | 12.68 d |
| Fprob | <0.001 | <0.001 | <0.001 | <0.001 | <0.001 | <0.001 | <0.001 | <0.001 |

Petri relative

| | | | | | | | | |
|---|---|---|---|---|---|---|---|---|
| CS | 100% | 100% | 100% | 100% | 100% | 100% | 100% | 100% |
| CS_poly | 57% | 61% | 56% | 57% | 60% | 63% | 70% | 73% |
| PS | 100% | 100% | 100% | 100% | 100% | 100% | 100% | 100% |
| PS_poly | 57% | 51% | 61% | 58% | 58% | 58% | 59% | 60% |

PAS analyzer in kgN/ha

| | | | | | | | | |
|---|---|---|---|---|---|---|---|---|
| 0 | 0.013 a | 0.06 a | 0.21 a | 0.36 a | 0.48 a | 0.68 a | 0.84 a | 0.91 a |
| CS | 0.072 c | 0.44d | 1.31 c | 1.92 c | 2.19 c | 2.39 c | 2.52 c | 2.57 c |
| CS_poly | 0.047 b | 0.25 b | 0.81 b | 1.21 b | 1.46 b | 1.65 b | 1.85 b | 1.92 b |
| PS | 0.131 d | 0.75 e | 2.98 e | 5.24 e | 6.57 e | 6.67 3 | 7.27 e | 7.35 e |
| PS_poly | 0.069 c | 0.37 c | 1.59 d | 3.04 d | 3.82 d | 3.95 d | 4.42 d | 4.50 d |
| Fprob | <0.001 | <0.001 | <0.001 | <0.001 | <0.001 | <0.001 | <0.001 | <0.001 |

PAS relative

| | | | | | | | | |
|---|---|---|---|---|---|---|---|---|
| CS | 100% | 100% | 100% | 100% | 100% | 100% | 100% | 100% |
| CS_poly | 62% | 58% | 62% | 63% | 67% | 69% | 73% | 74% |
| CS | 100% | 100% | 100% | 100% | 100% | 100% | 100% | 100% |
| PS_poly | 53% | 49% | 53% | 58% | 58% | 59% | 61% | 61% |

### Emission of Greenhouse Gases

The cumulative results after 10 days in Table 4 show that there is a significant difference in the level of CO₂ and N₂O emission between pig slurry and cattle slurry but there is almost no effect of the addition of polyhalite. Only for N₂O and pig slurry there is a significant effect of polyhalite. For N₂O emission the difference between CS and PS is more than a factor 3. In total the addition of NH₄—N with CS and CS_poly to soil resulted in a 3.0% loss as N₂O—N(from the slurry compared to the zero).

For PS and PS_poly this was significantly higher with a 8.2 and 7.0% loss as N₂O—N. The relatively high N₂O emissions may result from the fact that the soil and slurry remain moist. The higher amount easily decomposable organic matter in pig slurry may have caused the high N₂O emissions in PS and PS poly. In contrast CH₄ emission is for both slurries the same despite their different composition.

TABLE 4
The cumulative CO₂, N₂O and CH₄ emission (kg/ha)
after day 10 measured with the PAS analyzer

| | | |
|---|---|---|
| CO₂ | N₂O | CH₄ |

| | | | | | | |
|---|---|---|---|---|---|---|
| 0 | 1439 | a | 0.862 | a | 3.159 | a |
| CS | 1797 | b | 1.520 | b | 4.145 | b |
| CS_poly | 1768 | b | 1.534 | b | 4.166 | b |
| PS | 2227 | d | 5.468 | d | 4.108 | b |
| PS_poly | 2250 | d | 4.791 | c | 4.356 | b |

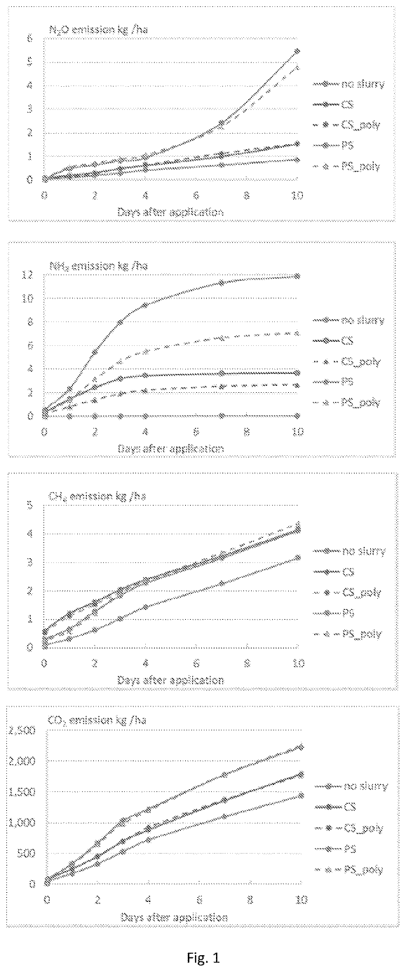

Reference is made to FIG. 1, which depicts graphs showing the effect of polyhalite addition to cattle (CS_poly) and pig (PS_poly) compared to no addition of polyhalite. The NH₃ emission is based on acid trap measurements.

The development of the emission of the greenhouse gasses is shown in FIG. 1 and Table 5 (and also NH₃). The effect of addition of polyhalite on the greenhouse gas emissions is minimal. Only in case of pig slurry and N₂O a difference appears after 5 days.

TABLE 5
Cumulative CO₂, N₂O and CH₄ emission from day zero to 10 (kg/ha) measured with the PAS
analyzer. Also the relative emission of “poly” versus the untreated slurry is presented

| | | | | | | | | |
|---|---|---|---|---|---|---|---|---|
| Treatment | Day 0.04 | Day 0.3 | Day 1 | Day 2 | Day 3 | Day 4 | Day 7 | Day 10 |

CO₂

| | | | | | | | | |
|---|---|---|---|---|---|---|---|---|
| No slurry | 10.7 a | 45.8 a | 172 a | 328 a | 528 a | 720 a | 1099 a | 1439 a |
| CS | 20.6 b | 78.5 b | 249 b | 450 b | 703 b | 883 b | 1362 b | 1797 b |
| CS_poly | 20.9 b | 83.5 bc | 250 b | 452 b | 697 b | 922 b | 1374 b | 1768 b |
| PS | 24.7 c | 84.4 c | 334 c | 672 c | 1031 d | 1221 c | 1779 c | 2227 c |
| PS_poly | 26.1 c | 87.4 c | 324 c | 654 c | 988 c | 1198 c | 1781 c | 2250 c |
| Fprob | <0.001 | <0.001 | <0.001 | <0.00 | <0.00 | <0.00 | <0.00 | <0.00 |

CO₂

| | | | | | | | | |
|---|---|---|---|---|---|---|---|---|
| CS | 100% | 100% | 100% | 100 | 100 | 100 | 100 | 100 |
| CS_poly | 97% | 101% | 96% | 96% | 94% | 99% | 96% | 94% |
| PS | 100% | 100% | 100% | 100 | 100 | 100 | 100 | 100 |
| PS_poly | 101% | 99% | 92% | 93% | 96% | 93% | 95% | 96% |

N₂O

| | | | | | | | | |
|---|---|---|---|---|---|---|---|---|
| No slurry | 0.010 a | 0.033 a | 0.109 a | 0.19 a | 0.28 a | 0.41 a | 0.62 a | 0.86 a |
| CS | 0.017 c | 0.086 b | 0.181 a | 0.30 b | 0.47 b | 0.60 b | 0.99 b | 1.52 b |
| CS_poly | 0.016 bc | 0.047 ab | 0.146 a | 0.27 ab | 0.49 b | 0.63 b | 1.12 b | 1.53 b |
| PS | 0.013 b | 0.067 ab | 0.488 b | 0.64 c | 0.82 c | 0.94 c | 2.41 d | 5.46 d |
| PS_poly | 0.013 b | 0.070 ab | 0.551 b | 0.71 c | 0.89 c | 1.05 c | 2.26 c | 4.79 c |
| Fprob | 0.002 | 0.281 | <0.001 | <0.00 | <0.00 | <0.00 | <0.00 | <0.00 |

N₂O

| | | | | | | | | |
|---|---|---|---|---|---|---|---|---|
| CS | 100% | 100% | 100% | 100 | 100 | 100 | 100 | 100 |
| CS_poly | 95% | 54% | 81% | 92% | 103 | 106 | 113 | 101 |
| PS | 100% | 100% | 100% | 100 | 100 | 100 | 100 | 100 |
| PS_poly | 101% | 104% | 113% | 111 | 109 | 112 | 94% | 88% |

CH₄

| | | | | | | | | |
|---|---|---|---|---|---|---|---|---|
| No slurry | 0.026 a | 0.093 a | 0.327 a | 0.62 a | 1.02 a | 1.43 a | 2.25 a | 3.15 a |
| CS | 0.220 e | 0.585 e | 1.203 e | 1.60 c | 2.03 b | 2.39 b | 3.22 b | 4.14 b |
| CS_poly | 0.201 d | 0.535 d | 1.117 d | 1.52 c | 1.96 b | 2.34 b | 3.21 b | 4.16 b |
| PS | 0.102 c | 0.290 c | 0.664 c | 1.27 b | 1.83 b | 2.27 b | 3.14 b | 4.10 b |
| PS_poly | 0.092 b | 0.255 b | 0.586 b | 1.22 b | 1.91 b | 2.35 b | 3.33 b | 4.35 b |
| Fprob | <0.001 | <0.001 | <0.001 | <0.00 | <0.00 | <0.00 | <0.00 | <0.00 |

CH₄

| | | | | | | | | |
|---|---|---|---|---|---|---|---|---|
| CS | 100% | 100% | 100% | 100 | 100 | 100 | 100 | 100 |
| CS_poly | 91% | 91% | 93% | 95% | 97% | 98% | 99% | 101 |
| CS | 100% | 100 | 100 | 100 | 100 | 100 | 100 | 100 |
| PS_poly | 88% | 88% | 88% | 96% | 105 | 104 | 106 | 106 |

### DISCUSSION

As mentioned before the application of polyhalite (Table 3) showed an immediate reduction effect, which was roughly the same for CS as for PS.

After day 1 it was on average (PAS analyzer and Petri dish) slightly more than 40%, between day 1 and 4 35-40%.

The pattern in reduction was exactly the same with the Petri-dishes as with the PAS-analyzer. In case of application in outdoors in the field mostly only the first few days are relevant. They determine largely the total ammonia emission. So based on this results and if they may be extrapolated to field conditions an overall reduction of 40% might be likely under field conditions.

One possible reason for the immediately sharp reduction in NH₃ emission can be the formation of struvite. From slurries it is known that struvite can be formed—a mineral that contains Mg, NH₄ and PO₄—especially in pig slurry. In this way a part of the NH₄_{⁺} is chemical bounded and not available for NH₃ emission. The addition of extra Mg via polyhalite could enhance the formation of struvite. Ideally its composition is a 1:1:1 ratio resulting in NH₄MgPO₄, but in fact struvite is a whole group of minerals, including for example, Newberyite (HMg(PO₄)·3H₂O), Phosphorrosslerite HMg(PO₄)·7H₂O, Struvite (NH₄Mg(PO₄)·6H₂O or KMg(PO₄)·6H₂O), Schertelite ((NH₄)₂H₂Mg(PO₄)₂·4H₂O), Stercorite (NH₄NaH(PO₄)₂·8H₂O), Hannayite ((NH₄)₂H₄Mg₃(PO₄)₄·8H₂O). Model calculations indicate that hydroxyapatite and struvite occur in the pH range of 7-8, above pH 8 struvite and calcite dominate. Below a pH of 7.4, struvite and calcite are unstable. Slurries generally have a high pH. So a pure struvite with a 1:1:1 ratio for Mg, NH₄ and PO₄. is not often realized. On average, a nitrogen content in the dry matter of 11.8 g N per kg, with a range of 1.0 to 30.3 g N per kg may be found. For phosphate (P₂O₅) the average is 213 with a range of 124 to 357 g per kg; for magnesium (as MgO) the average is 252 with a range of 32 to 696 g MgO per kg.

TABLE 6
The amount of N, P and Mg present in slurry and the extra
Mg via the addition of 5% polyhalite to slurry. Calculated
is in which N:P:Mg ratios (on a molar basis) this results.

| | | | polysulphate |
|---|---|---|---|
| Component | CS | PS | addition |
| N (g kg⁻¹) | 1.1 | 2.8 | 0 |
| P (g kg⁻¹) | 0.86 | 1.65 | 0 |
| Mg (g kg⁻¹) | 1.3 | 1.3 | 1.81 |
| Struvite ideally N:P:Mg(1:1:1) | | | |
| ratio N:P:Mg(poly) | 1:0.35:0.95 | 1:0.27:0.37 | |
| ratio N:P:Mg(poly + slurry) | 1:0.35:1.63 | 1:0.27:0.64 | |

In Table 6 the stoichiometric composition of the slurry is calculated with regard to the possibility of struvite formation. The data show that ideally 35% and 27% of the NH₄—N in slurry could be fixed in struvite. The data also show that even without the addition of polyhalite enough Mg is present to fix all phosphate. However from literature it is known that an excess of Mg is needed to enhance the formation of struvite. In fact the conditions whereunder struvite precipitation is enhanced are quite complex. Most likely the formation of struvite is not the only process that causes a reduction in NH₃ emission. This becomes most clear from the data of the pig slurry. The amount of NH₄—N present in the slurry is so high that ideally only 27% of it can be fixed based on the amount of P present in the slurry, whereas the emission reduction is around 40%. In addition the supply of polyhalite causes relatively a much stronger increase of the surplus of Mg compared to P for cattle slurry (a factor 4.7) then for pig slurry (a factor 2.4), which indeed suggests that either small amounts are enough and or that other processes are involved. It could be possible to use polyhalite for all or a larger share of the slurry available on a dairy farm (roughly 50 m³/ha) without applying too much Mg or S. At 5% addition of polyhalite every m³ of slurry receives 9.5 kg S. In case of 50 m³/ha this would amount to 475 kg S/ha. For cattle slurry it is therefore evident that lower additions of polyhalite will still result in a large reduction in NH₃ emission. For pig slurry there is probably less scope to lower the amount of polyhalite given the much narrower Mg to P ratio (Table 6). On the other hand (arable) farmers seldomly apply more than 20 m³/ha because of the restrictions they have regarding the amount of P they are allowed to apply on their soils.

Given the N:P:Mg ratios in the slurry and that the fact that not all P in manure is orthophosphate (This may vary between 60% for farmyard manure to 90% for cattle slurry). For pig slurry it is mostly around 95%. In contrast it may be valued that of about 60% mineral phosphate in cattle slurry and pig slurry and that no perfect 1:1:1 struvite formation takes place or that already a part of the phosphate is present as struvite it is unlikely that the observed effects on NH₃ reduction can be totally contributed to the formation of struvite. Other possibilities are that i) the addition of polyhalite affects the ionic strength, ii) increases the specific surface in the slurry making adsorption of NH₃ possible and iii) “other” precipitation reactions with NH₄_{⁺} take place.

Polyhalite is partly soluble in water. This may rise the ionic strength of the solution. An increasing ionic strength means a lower activity coefficient of NH₄_{⁺} and thereby also a lower NH₃ gas pressure (concentration). However the addition of polyhalite may lead to the formation of gypsum. This requires Ca₂_{⁺} which is present in the polyhalite mineral but also in the slurry (in solution as well as in adsorbed form on the negatively charged organic matter in the slurry). When gypsum formation takes place then also Ca₂_{⁺} may be released from the negatively charged surface of organic matter. In that case the Ca₂_{⁺} is replaced by mainly K⁺ and NH₄_{⁺}. It is unknown to what extent this occurs, but if this takes place then the NH₄_{⁺} concentration in solution is lowered and thereby the driving force for NH₃ emission. Model calculations and or additional testing may give more insight. In the latter case standardized mixtures or organic matter (from 0 to x), ammonium-bicarbonate and polyhalite can be made to check the effect on NH₃ emission.

In the description of the mineral polyhalite it is mentioned that the material is fibrous and given the mineral structure of the material and the way it is formed in nature it is thinkable that it has a large specific surface. If that is the case NH₃ (which is a small molecule, bond length about 1 Angstrom) may be adsorbed on the internal surface with the Van der Waal forces as the driving force. But if the mineral partly dissolves this effect does not take place or is of minor importance.

Other precipitation reactions of NH₄_{⁺} are probably unlikely. Most salts based on ammonium have a high solubility. It is unknown if NH₄_{⁺} can replace a part of the K⁺ in the polyhalite crystal, since both components have roughly the same ionic radius. The polyhalite crystal contains 6% CaO. In principle Ca₂_{⁺} dissolved form the mineral can also react with carbonate. The solubility product of calcite (log K=−8.35) is lower than that of gypsum (log K=−4.61) which favors calcite formation, however there can be many intermediates like CaCO₃_{^{o}} which has a much higher solubility product (so calcite formation may perhaps not occur). If it does occur then a carbonate (CO₃²⁻) ion is removed from the solution, which will cause extra dissociation of HCO₃_{⁻}, whereby H⁺ is released which would cause a lowering of the pH. In principle this should also result in less CO₂ emission. This is however not the case based on the measurement results of Table 4 which show no difference in CO₂ emission. So calcite or intermediate products seem unlikely.

In the setup of the experiment polyhalite was mixed through the slurry, shortly (1-2 hrs.) before the manure was applied in the open slots. An effect on the reduction of the NH₃ emission was immediately observed with a slight weakening after 10 days. This raises the question if the observed emission effects depend on the time of application of polyhalite. Is the effect on emission different when polyhalite was applied a week, a month or longer before the emission reduction is measured. If the effect on NH₃ emission is independent of the time of application of polyhalite then there are also opportunities to apply it in the slurry pit of a dairy stable.

However if struvite formation is the dominant process then perhaps larger struvite crystals may be formed which will sink to the bottom of the slurry pit. From pig slurry storage facilities it is known that struvite can be presented on the bottom of the slurry pit.

To conclude, formation of struvite is most likely the main reason for a lower NH₃ emission. Possible other effects like lowering the activity coefficient of NH₄_{⁺} due to an increased ionic strength and exchange of NH₄_{⁺} against Ca₂_{⁺} from the adsorption complex (the slurry organic matter) due to gypsum formation are the most likely additional causes for the strong reduction in NH₃ emission. In addition it is thus far unknown if NH₃ adsorption on the internal surface of polyhalite mineral can take place.

### Greenhouse Gasses

The measurements showed that there is in fact no effect of polyhalite addition on greenhouse gasses. For CO₂ a reduction could be possible if the carbonate ion reacts with calcium that is present in the polyhalite. Slurries contain no N₂O from themselves. It can be formed when ammonium is oxidized into nitrate or when denitrification takes place.

This can take place at the slurry air interface. Indeed a relatively high amount of N₂O is measured. Only in case of pig slurry the addition of polyhalite has a reduction effect on N₂O emission. It is unclear what the reason behind this process is. Perhaps it is simply a lower availability of NH₄_{⁺} due to the processes described in the preceding chapter.

A reduction in methane by adding polyhalite was not measured.

### Example 2

### Experimental Setup

The performance of solid waste (solid fraction of pig slurry) composting was evaluated in a lab-scale set-up designed to perfectly monitor and control the bioprocess. The set-up allows collecting and analyzing the gaseous emissions, leachates and solid waste. Mixture, moisture, aeration, etc. are controlled during the composting process while temperature profiles and oxygen uptake rates are monitored. The system integrates twin separate composters with a capacity of 100 L each. The twin composters have independent control and monitoring systems; it allows performing two composting processes in parallel, one of them working as the control (blank) process while the second one works as the modified process in which prior to composting the slurry was mixed with 2% or 10% of polyhalite.

### Results

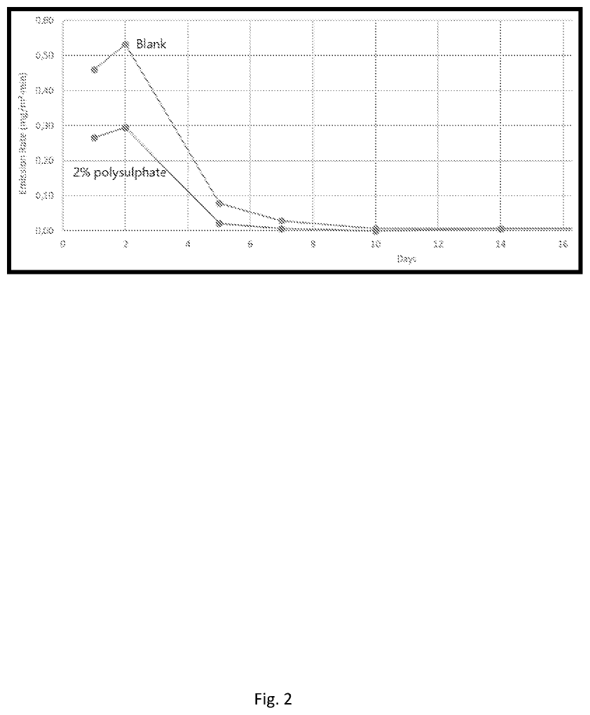

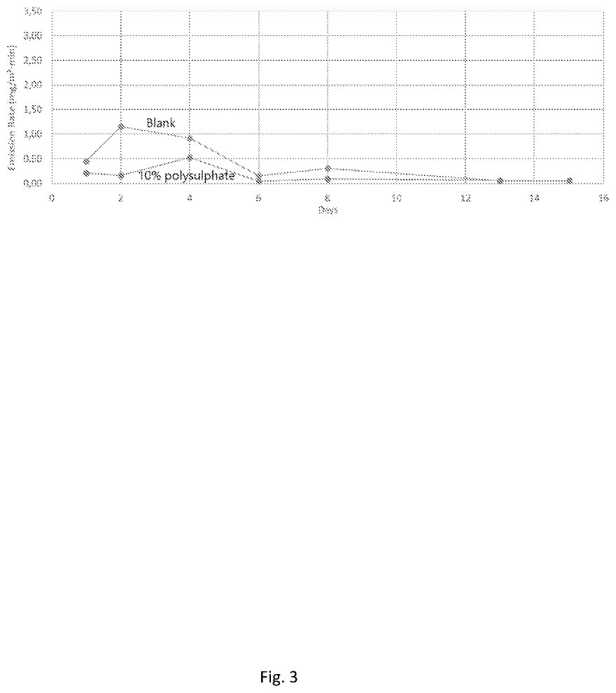

NH₃ emissions profile can be seen in FIGS. 2 and 3. Addition of both 2% and 10% polyhalite to the manure reduced NH₃ emission from composting throughout the entire duration of the experiment totally by more than 40% and 70% respectively. The reason the NH₃ emission period is lower than in reality is due to the difficulty in maintaining heat conservation in laboratory composting system.

### Example 3

### Plant Trial

### Experimental Setup

80MT [metric ton] pile of manure for composting was prepared and treated by the routine methods of the plant. 40% cow manure, 40% organic waste (bio-gas plant) and 20% chicken manure were mixed and then split into two similar piles, one untreated “blank” and one mixed with 1MT of polyhalite (5% w/w). The piles were turned over every 2-3 weeks to allow aerobic conditions and wettened once after 40 days. Temperature sensors were inserted deep in the piles and connected to a data logger. Ammonia emissions were collected twice a week from 3-5 different points across the piles.

### Results

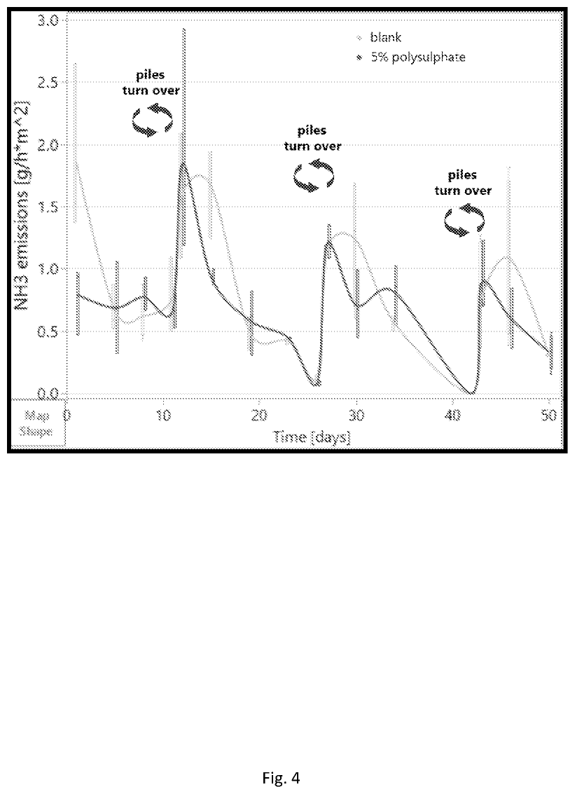

NH₃ emissions profile can be seen in FIG. 4. Every time the piles were turned over, NH₃ emissions rose. For the blank pile the emissions stayed at the same initial value for around 3-4 days. Contrary to that, for the polyhalite premixed pile, NH₃ emissions started to go down sooner and after 3-4 days the value is reduced. About 7 days after every turn-over, NH₃ emissions of both piles are similar. The reduced values within the first week after every turn-over can be accounted for a reduction of about 20% in NH₃ emissions by premixing a composting pile with 5% w/w of polyhalite.

While this invention has been described in terms of some specific examples, many modifications and variations are possible. It is therefore understood that within the scope of the appended claims, the invention may be realized otherwise than as specifically described.

1. A composition comprising Polyhalite and manure, wherein said Polyhalite is in a concentration between 0.1-10% w/w.

2. The composition of claim 1, wherein said Polyhalite is in a concentration between 0.5-5% w/w and said manure is solid.

3. The composition of claim 2, exhibiting a reduction in gas emissions at a level of at least 30% after two days of application to the ground, when compared to manure alone.

4. The composition of claim 1, further comprising Zeolite in a concentration of between 0.1-5% w/w.

5. The composition of claim 1, further comprising an additive selected from the group including Urease inhibitor, Nitrification inhibitor, Denitrification inhibitor, Basal rock, Biochar, Hydrochar or a combination thereof.

6. The composition of claim 1, wherein the ratio between said polyhalite and said manure is 1:19, respectively.

7. A method for reducing the NH₃ emission from animal manure application comprising at least two steps, a first step comprising applying said animal manure into a soil and a second step comprising applying polyhalite over said applied manure.

8. (canceled)

9. The method of claim 7, wherein said polyhalite is in a solid form selected from the group including a powder, granule and the like.

10. The method of claim 7, wherein said polyhalite is in liquid form selected from the group including melt or a suspension.

11. The method of claim 10, wherein said Polyhalite is in the form of a suspension having a concentration of no more than 10% w/w Polyhalite.

12. The method of claim 10, wherein said second step comprises spraying said polyhalite suspension over said applied manure.

13. The method of claim 7, further comprising mixing polyhalite and Zeolite with manure to provide a fertilizer composition, wherein said composition is spread in an agricultural field.

14. The method of claim 13, wherein said ratio of Polyhalite to Zeolite is 1:1, and concentration of polyhalite and Zeolite is less than 10% w/w each.

15. Use of Polyhalite for the reduction of NH₃, N₂O, CH₄ or CO₂ emissions from animal manure, comprising applying said Polyhalite to said animal manure to form a polyhalite-manure composition.

16. The use according to claim 15, wherein said polyhalite-manure composition comprises less than 10% w/w of Polyhalite.

17. (canceled)

18. (canceled)
